(19) United States
(12) Patent Application Publication
(10) Pub. No.: US 2026/0187428 A1
(43) Pub. Date: Jul. 2, 2026

(54) Systems and Methods for Sparsity in Machine-Learned Models

(71) Applicant: Google LLC, Mountain View, CA (US)

(72) Inventors: Amir Yazdanbakhsh, San Jose, CA (US); Suvinay Subramanian, Sunnyvale, CA (US); Shivani Agrawal, Sunnyvale, CA (US); Zhonglin Han, Menlo Park, CA (US)

(21) Appl. No.: 19/436,902

(22) Filed: Dec. 30, 2025

Related U.S. Application Data
(60) Provisional application No. 63/740,122, filed on Dec. 30, 2024.

(51) Int. Cl. G06N 3/0495; G06N 3/096

(52) U.S. Cl. CPC G06N 3/0495; G06N 3/096

(57) ABSTRACT

A machine learning method and system are described for inducing and exploiting sparsity in machine-learned models. The technology can include fine-tuning a machine-learned model during a first set of training steps. The machine-learned model can be pre-trained prior to fine-tuning. The technology can include generating a sparsity mask for at least one of a plurality of tensors of the machine-learned model after the first set of training steps and applying the sparsity mask to the at least one of the plurality of tensors of the machine-learned model. The sparsity mask includes a zero value for at least one element within each block of the at least one of the plurality of tensors. The technology includes fine-tuning the machine-learned model during a second set of training steps with the sparsity mask applied to the at least one of the plurality of tensors.

### RELATED APPLICATIONS

This application is based upon and claims the right of priority to U.S. Provisional Application No. 63/740,122, filed on Dec. 30, 2024, the disclosure of which is hereby incorporated by reference herein in its entirety for all purposes.

### FIELD

The present disclosure relates generally to machine learning, and more particularly to systems and methods for inducing and exploiting sparsity in machine-learned models.

### BACKGROUND

Artificial intelligence systems increasingly include large foundational machine-learned models which have the capability to provide a wide range of new product experiences. As these large foundational models, also referred to as core models, become more prevalent, so too has the need to provide computationally efficient models for deployment in scenarios ranging from edge devices to large infrastructures serving downstream devices. Sparsity has recently emerged as a paradigm for increasing the computational efficiency of deep neural networks (DNNs). While sparsity shows promise for reducing computational workloads, there exists a tradeoff between model quality and performance improvements. Existing techniques may over-index on model quality which can lead to lost performance improvements or may over-index on performance improvements which can lead to unacceptable losses in model quality.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by a computing system comprising one or more computing devices. The method includes fine-tuning a machine-learned model during a first set of training steps, the machine-learned model having been pre-trained on at least one set of training data. The method includes generating a sparsity mask for at least one of a plurality of tensors of the machine-learned model after the first set of training steps and applying the sparsity mask to the at least one of the plurality of tensors of the machine-learned model, the sparsity mask including a zero value for at least one element within each block of the at least one of the plurality of tensors. The method includes fine-tuning the machine-learned model during a second set of training steps with the sparsity mask applied to the at least one of the plurality of tensors.

Another example aspect of the present disclosure is directed to a system including one or more processors and one or more non-transitory computer-readable media that collectively store instructions that when executed by the one or more processors, cause the one or more processors to perform operations. The operations include fine-tuning a machine-learned model during a first set of training steps, the machine-learned model having been pre-trained on at least one set of training data. The operations include generating a sparsity mask for at least one of a plurality of tensors of the machine-learned model after the first set of training steps and applying the sparsity mask to the at least one of the plurality of tensors of the machine-learned model, the sparsity mask including a zero value for at least one element within each block of the at least one of the plurality of tensors. The operations include fine-tuning the machine-learned model during a second set of training steps with the sparsity mask applied to the at least one of the plurality of tensors.

Yet another example aspect of the present disclosure is directed to one or more non-transitory computer-readable media storing computer instructions, that when executed by one or more processors, cause the one or more processors to perform operations, the operations include fine-tuning a machine-learned model during a first set of training steps, the machine-learned model having been pre-trained on at least one set of training data. The operations include generating a sparsity mask for at least one of a plurality of tensors of the machine-learned model after the first set of training steps and applying the sparsity mask to the at least one of the plurality of tensors of the machine-learned model, the sparsity mask including a zero value for at least one element within each block of the at least one of the plurality of tensors. The operations include fine-tuning the machine-learned model during a second set of training steps with the sparsity mask applied to the at least one of the plurality of tensors.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram depicting an example computing environment including a machine learning training and deployment system that is configured to induce and exploit sparsity in machine-learned models according to example implementations of the present disclosure;

FIG. 2 is a diagram depicting an example of training operations for an example machine-learned model according to example implementations of the present disclosure;

FIG. 3 depicting an example computing environment that illustrates sparsity aware fine-tuning according to example implementations of the present disclosure;

FIG. 4 is a block diagram depicting an example of a tensor and a process of computing a sparsity mask for the tensor according to example implementations of the present disclosure;

FIG. 5 is a block diagram depicting an example of a tensor and particular values to further illustrate a technique of masking to induce sparsity according to example implementations of the present disclosure;

FIG. 6 is a flow chart diagram illustrating an example method for training a machine-learned system according to example implementations of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 depicts a block diagram of an example networked computing system that can perform aspects of example implementations of the present disclosure;

FIG. 15 is a block diagram of an example computing device according to example implementations of aspects of the present disclosure; and

FIG. 16 is a block diagram of an example computing device according to example implementations of aspects of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine learning systems and a framework for inducing and exploiting sparsity in machine-learned models such as foundational models including large-language models (LLMs). Sparsity is an emerging paradigm in machine learning that enables increases in the computational efficiency of machine-learned models including deep neural networks (DNNs). A tensor may exhibit sparsity due to the presence of one or more zeros in a block of values of the tensor. For example, a tensor can be said to exhibit 1:4 semi-structured sparsity if any aligned contiguous block of four elements, there exists at most one non-zero value. The location of the non-zero value may vary from block to block. Embodiments of the present disclosure include a training framework for training a machine-learned model so as to induce sparsity within one or more tensors of the machine-learned model. Once trained within this framework, the machine-learned model can be deployed in a manner so as to exploit the sparsity induced during training. For example, the model can be deployed for processing by one or more tensor processing units that are configured to identify and exploit sparsity during inference. A tensor processing unit can be configured to skip one or more computations (e.g., matrix multiplications) when sparsity is present in a tensor, leading to computational savings. Additionally, the sparsity within the tensors can be exploited by only storing and/or communicating non-zero values so as to reduce memory storage and communication requirements.

In accordance with an example embodiment of the present disclosure, a machine learning training and deployment system is provided for inducing sparsity during training of machine-learned models and exploiting the induced sparsity during deployment of the models. During training, sparsity can be induced or otherwise applied to one or more tensors of a machine-learned model such as a large language model. For example, N:M sparsity can be applied to a set of one or more tensors of the machine-learned model, where N is a first integer and M is a second integer that is greater than the first integer such that there exists at most N nonzero values in every set of M contiguous elements of a tensor. The N:M sparsity can be applied to tensors such as weights and activations and can be applied to various data types. For example, N:M sparsity can be applied to feed-forward (FF) weights in LLMs to provide large performance benefits during inference. For example, if any one operand is sparse, the system can realize compute and performance benefits in the TPU performing the calculation. N:M sparsity can additionally or alternatively be applied to feed-forward activations as well. Sparsity may also be applied to operations including query, key, value (QKV) calculations of transformers, output projections, and caching (e.g., KV-cache), and other operations.

It has been observed, for example, that N:M sparsity including 2:4 sparsity can be quality neutral for inference across a wide range of large language models and other models as well that are not language models. The use of sparsity can be synergistic with a variety of numerics and can augment various data formats. Various types of processing units, such as tensor processing units can be configured to augment a matrix multiply unit (MXU) to support N:M sparsity such as 1:4 sparsity or 2:4 sparsity. This can provide up to 4× performance in some instances through FLOPs and bandwidth savings and enable various patterns. With induced sparsity, such systems can provide improved end-to-end performance for inference.

According to an example aspect of the present disclosure, a machine learning training system can induce sparsity during fine-tuning of a machine-learned model. For example, a machine-learned model can be pre-trained using one or more training datasets. Subsequent to pre-training, the model can be fine-tuned. The model can undergo standard or dense fine-tuning for a first set of fine-tuning steps representing a fraction of the overall fine-tuning steps. By way of example, the model can undergo dense fine-tuning for 1/10th of the overall fine-tuning steps. Other fractions of the overall fine-tuning steps can be used. After this initial fine-tuning, the training system can compute an N:M (e.g., 1:4, 2:4, etc.) sparsity mask for each of a plurality of tensors of the model. The sparsity mask can be computed using various techniques such as by selecting the most significant tensor elements and masking the remaining elements. For example, the system can compute the mask by computing the top N values in each block of M values and generating a mask for the elements of the remaining values in each block. The system can apply the mask to each tensor by replacing the value of each masked element with a zero value. After applying a respective mask to each tensor, the system can continue fine-tuning the model for the remaining fine-tuning steps (e.g., 9/10 of the fine-tuning steps). By fine-tuning for a larger number of steps with the mask applied, the training system can effectively recover quality that may be lost from masking. In some examples, additional fine-tuning such as reinforcement learning from human feedback can be performed after fine-tuning with the mask applied.

In accordance with an example aspect, a sparsity mask can be updated and reapplied. For example, a sparsity mask for a tensor can be recomputed after fine-tuning for a predetermined number of steps with the mask applied. The recomputed mask can then be applied and fine-tuning can continue until the end of fine-tuning or for another predetermined number of training steps. The mask can be recomputed and reapplied one or more times during fine-tuning. It is noted that the number of times the mask is recomputed will generally be much larger than the overall number of training steps. For example, recomputing the mask after every step may result in extended training times and compute usage, without a corresponding benefit in model quality. Thus, in example embodiments, the mask is applied for at least two training steps before being recomputed.

In some implementations, a machine-learned model may include multiple layers including an initial layer, final layer, and intermediate layers between the initial layer and the final layer. These layers can be identical layers in some examples. According to an example aspect of the present disclosure, applying sparsity during training of the initial layer and the final layer can be skipped or omitted such that sparsity is only applied to the intermediate layers. It has been observed that the initial and final layers may exhibit increased influence over model quality. With this observation, the first and last layers can be trained without masking so as to maximize model quality with respect to these layers.

After training, the machine-learned model with induced sparsity can be deployed in a manner to exploit the sparsity. Memory storage and communication can be reduced by not storing and transporting the zero values for elements. Additionally, model computations such as matrix multiplications with the zero values can be skipped. In some examples, the model can be deployed for processing by one or more processing units such as a tensor processing unit. The tensor processing unit can be configured to skip calculations when sparsity is identified. In some examples, sparse tensors can be indicated to the processing unit so that calculations can be skipped to save computations resources.

Systems and methods in accordance with embodiments of the present disclosure provide a number of technical effects and benefits. A machine learning training and deployment system can be configured to induce sparsity during training that can be exploited during deployment to effect computational savings by processor(s) serving the trained and deployed models. Moreover, the induced sparsity can be exploited to effect memory storage savings and memory communication savings. More particularly, during processing, computations such as multiplications of tensors exhibiting sparsity can be skipped for sparse elements. Additionally, the zero value elements of the tensors do not have to be stored or communicated, leading to memory storage and bandwidth improvements.

Much of the following disclosure refers to large language models as specific examples of sequence processing models but it will be appreciated that the disclosure is equally applicable to any type of sequence processing model. For example, the disclosed technology can be used with large image models, multimodal models, and other types of foundational models. For instance, the generative models can operate in domains other than the text domain, such as image domains, audio domains, biochemical domains, etc. For instance, a sequence processing model may be used to process sequential inputs for robotic controls and other tasks. Similarly, the generative model and/or the downstream applications can be configured to perform any number of tasks. For instance, if the inputs to the generative model and/or a downstream application are images or features that have been extracted from images, the output generated by the generative model for a given image can be scores for each of a set of object categories, with each score representing an estimated likelihood that the image contains an image of an object belonging to the category. As another example, if the inputs to the generative model and/or a downstream application are sensor data, the outputs can be robotic control signals. The system can analyze the distance of generated signals relative to a target domain (e.g., using intended signals) to determine the validity of the generated signals.

As another example, if the input to the sequence processing model is a sequence representing a spoken utterance, the output generated can be a score for each of a set of pieces of text, each score representing an estimated likelihood that the piece of text is the correct transcript for the utterance.

As another example, if the input to the sequence processing model is a sequence of physiological measurements, the output generated may be a score for each of a set of possible diagnoses for the condition of a user, with the score representing an estimated likelihood that the diagnosis is accurate. In example embodiments, the controller can assess whether the physiological measurements are relevant to a particular domain (e.g., a diagnosis). In such a case, the system could detect whether the physiological measurements match a particular diagnosis associated with the measurements.

As another example, if the input to the sequence processing model is a sequence of text from a received communication, the output generated may be a score for each of a set of possible responses to the received communication, with the score representing an estimated likelihood that the response matches a user's intent.

As another example, if the input to the sequence processing model is indicative of a particular function to be performed by an apparatus (such as a robot), the output generated may be a score for each of a set of possible control signals for controlling the apparatus, with the score representing an estimated likelihood that the control signals match the particular function to be performed.

As another example, if the input to the sequence processing model includes natural language indicative of a computer implemented operation, the output generated may be a score for each of a set of possible computer-readable code segments, with the score representing an estimated likelihood that the computer-readable code segments match the computer implemented operation.

As another example, if the input to the sequence processing model is a sequence of text in one language, the output generated may be a score for each of a set of pieces of text in another language, with each score representing an estimated likelihood that the piece of text in the other language is a proper translation of the input text into the other language.

Although a number of examples of tasks which may be performed by the sequence processing model and/or a downstream application are provided here, it will be understood that this is not exhaustive, and that the generative model and/or the downstream applications can be configured to perform any suitable task.

With reference now to the Figures, example embodiments of the present disclosure will be discussed in further detail.

### Example Model Arrangements

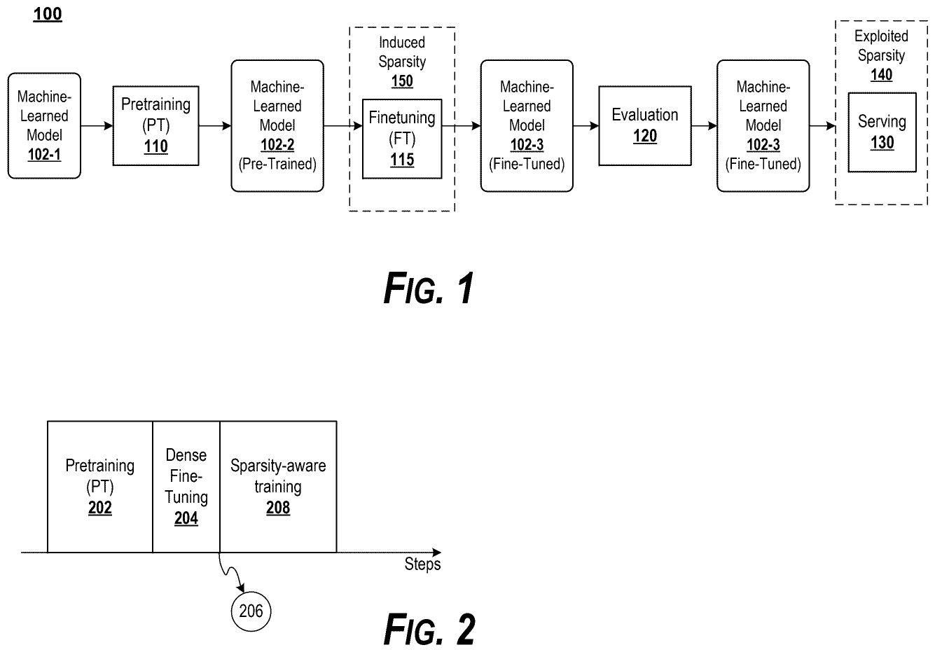

FIG. 1 is a block diagram depicting an example computing environment 100 including a machine learning training and deployment system that is configured to induce and exploit sparsity in machine-learned models. Computing environment 100 includes a machine-learned model 102 that undergoes training by a training computing system. Model 102, or data indicative of model 102, can be accessed by the training computing system which performs pretraining (PT) 110 of the model. The model can be pretrained using one or more training datasets.

The training or pretraining process can include defining a model architecture (e.g., encoder-decoder, decoder-only, encoder-only, etc.), defining a pre-training procedure (e.g., defining a loss such as masked-language model, causal-language model, mixture of denoisers, etc.), defining a model size (e.g., 1 billion (B) parameters, 8 B parameters, 24 B parameters, etc.), and defining the pre-training datasets. As an example, consider a foundational large language model which may undergo significant training on multiple processors over a long period of time using a large quantity of training data. Such a model may include 1 billion (B), 8 B, 16 B, 32 B, or more parameters. By way of example, the pretraining 110 process may include over a million training steps during which training samples are evaluated by the model. The pretraining process can be performed to generate tensors such as weights, activations, or any other logical tensor (e.g., in a matmul). The pretraining process results in a pre-trained machine-learned model 102-1 having a set of tensor values.

After pretraining, the pretrained model 102-1 can be accessed by the training computing system to perform fine-tuning (FT) 115 of the model. The model can be finetuned using one or more fine-tuning training datasets. The fine-tuning datasets can be particular datasets that are used to finetune the model for a particular task such as search, classification, etc. For example, fine-tuning the model can include training to adapt the model for a specialized downstream application. Fine-tuning may also be referred to as adaptive training or tuning. Various types of fine-tuning 115 can be performed in accordance with example embodiments. For example, fine-tuning can include instruction fine-tuning, human-feedback-fine-tuning via reinforcement learning or direct preference optimization. Other examples of fine-tuning can include prompt-tuning, quantization, or other inference runtime optimizations. Embodiments in accordance with the present disclosure can be used with any type of fine-tuning or adaptive training.

During fine-tuning 115, the training system can adapt the weights or other parameters of the pretrained model using downstream datasets in some examples. For example, the downstream datasets can include summarization data, composition data, question/answer data, dialogue data, or any other data that is used to fine-tune the model for a particular downstream application. As a result of fine-tuning, the downstream application can output entirely new substitute parameter weights for the pretrained model or a subset of substitute parameter weights for the pretrained model. In some examples, additional or new parameter weights can be added.

In accordance with embodiments of the present disclosure, the training system finetunes 115 the model for induced sparsity 150. The training system can perform dense or regular fine-tuning for a first number of fine-tuning steps followed by fine-tuning to induce sparsity for a second number of fine-tuning steps. The second number of fine-tuning steps can be larger than the first number. In this manner, the system can recover quality losses that may occur from inducing sparsity by masking. By way of example, the first number of fine-tuning steps can include a fraction (e.g., 1/10th) of the overall number of fine-tuning steps. For instance, a total of 100,000 fine-tuning steps may be performed, with 10,000 steps initially performed without inducing sparsity, followed by 90,000 steps that are performed while inducing sparsity. Other fractions and overall number of training steps can be used.

The training system can induce sparsity by computing a sparsity mask for one or more tensors of pretrained model 102-1. The training system can generate a sparsity mask for each of a plurality of tensors of model 102-1. For example, the training system can compute a sparsity mask for weights, activations, or other tensors of the model. The training system can generate the sparsity mask for a tensor by identifying the elements having the top N values in each block of M elements. For example, the training system can identify the elements having the top two values in a block of four elements. The training system can generate the sparsity mask for the tensor by masking the unselected elements in the block. For example, the training system can mask the two elements having the lowest values in the block by replacing the values in those elements with zeros.

After fine-tuning, the finetuned machine-learned model 102-2 can be accessed by the computing system for evaluation 120 of the model. Evaluation 120 is optional. After evaluation, the fine-tuned model 102-3 can be deployed for serving 130. This can include the exploited sparsity 140. The model can be deployed by one or more edge TPUs to serve a local computing system in some examples. In other examples, the model can be deployed by one or more datacenter TPUs to serve remote computing systems. The model can be deployed so as to exploit the sparsity induced during fine-tuning 115. For example, a TPU can be configured to skip one or more computations (e.g., matrix multiplications) when sparsity is present in a tensor, leading to computational savings. The model can be deployed for processing by a TPU configured to identify and exploit sparsity during inference. The model can be stored in a manner that reduces memory storage and communication requirements. For example, sparsity within the tensors can be exploited by only storing and/or communicating non-zero values so as to reduce memory storage and communication requirements.

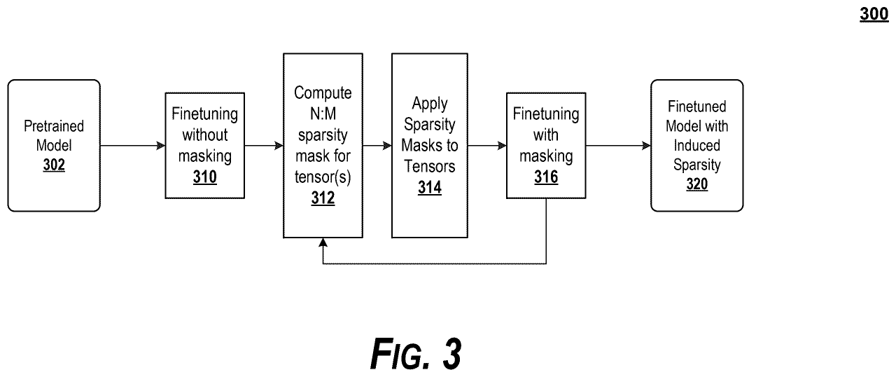

FIG. 2 is a diagram depicting an example of training operations for an example machine-learned model in accordance with an example embodiment. At 202, the model can undergo pretraining for a number of pretraining steps or iterations. For example, the model can undergo pretraining on a large dataset for a large number of steps or iterations. For example, pretraining can include one million or more training steps in an example implementation.

At 204, the model can undergo fine-tuning for a first number of fine-tuning steps. For example, the computing system can perform dense or standard fine-tuning on the model for a fraction of the overall number of fine-tuning steps (e.g., 100,000). In an example implementation, the computing system finetunes the model for 1/10th (e.g., 10,000) of the overall fine-tuning steps. Other numbers and fractions of fine-tuning steps can be used.

After standard or dense fine-tuning for the first number of fine-tuning steps, the computing system computes a sparsity mask for one or more tensors of the model at 206. By way of example, the computing system can induce N:M sparsity by performing a top N values in M elements computation to select the highest value elements in each block of a tensor and masking the unselected elements. For instance, the system can compute a top 1-in-4 for 1:4 structured sparsity of a tensor. The system can utilize other techniques to identify the most significant element(s) in a block of a tensor.

At 208, the model undergoes sparsity aware fine-tuning for the remaining number of fine-tuning steps. For example, the computing system can finetune the model with the sparsity mask applied to the unselected elements in each tensor.

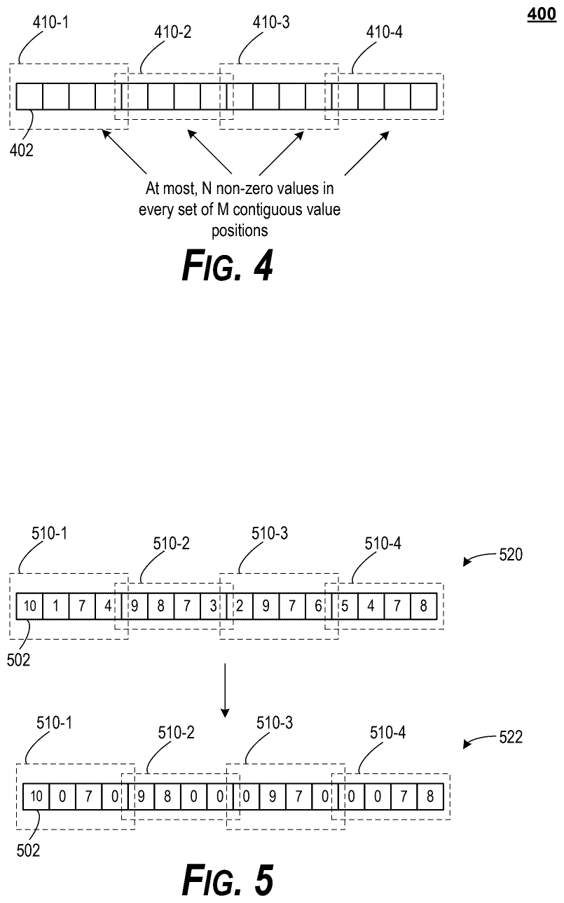

FIG. 3 is a block diagram depicting an example computing environment 300 that illustrates sparsity aware fine-tuning in accordance with an example embodiment of the present disclosure. A pre-trained model 302 is accessed by a training computing system and undergoes standard or dense fine-tuning without masking at 310. For example, the model can be finetuned without masking for a fraction of an overall number of fine-tuning steps. The number and fraction of fine-tuning steps at 310 can vary by embodiment. Generally, the number of non-masked fine-tuning steps is less than the number of masked fine-tuning steps so as to enable the model to train sufficiently to recover quality losses from initial masking.

After fine-tuning the model for a predetermined number of fine-tuning steps, the training system computes an N:M sparsity mask for a set of one or more tensors of the machine-learned model at 312. The system can compute a top N-in-M such as a top 1-in-4 or a top 2-in-4 to determine a sparsity mask for the less significant elements of a contiguous set of elements in a block of the tensor. The less significant elements can be selected as the lowest value elements in some examples.

The sparsity mask is applied to each tensor at 314. The sparsity mask can be applied by replacing the value of each of the less significant elements with a zero value. After masking each tensor, the computing system continues fine-tuning the model for a second number of fine-tuning steps at 316. In some examples, the sparsity mask can be recomputed and reapplied after a predetermined number of training steps with the mask applied. For example, after fine-tuning for less than all of the remaining fine-tuning steps, the computing system can recompute the sparsity mask using a top N-in-M calculation. The recomputed sparsity mask can be applied and fine-tuning performed for another predetermined number of training steps. In other examples, a single static sparsity mask is computed and applied for all the remaining steps of fine-tuning after unmasked fine-tuning. After completing the overall fine-tuning steps, the computing system can provide, store, and/or deploy the machine-learned model 320 including the induced sparsity.

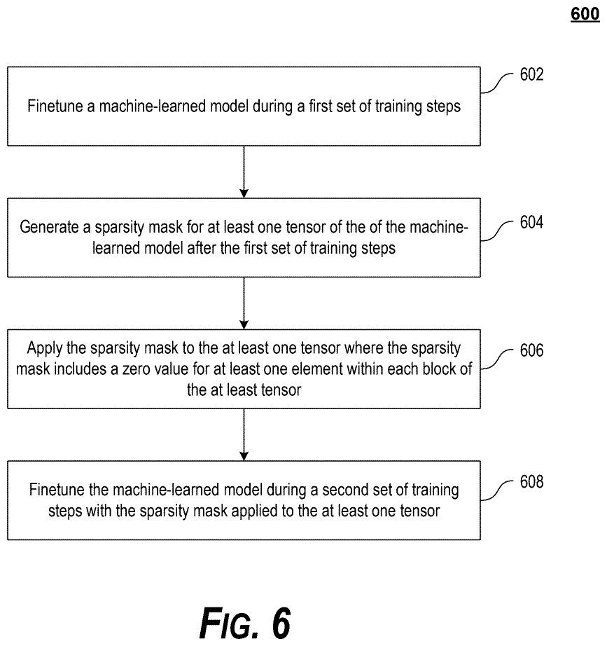

FIG. 4 is a block diagram depicting an example of a tensor 400 and a process of computing a sparsity mask for the tensor in accordance with example embodiments of the present disclosure. Tensor 400 includes 16 elements 402 for purposes of explanation. A block 410 is a contiguous set of elements 402. In this example, tensor 400 is divided into four blocks 410-1, 410-2, 410-3, and 410-4 to effectuate an M element scheme where M is four. In another example, tensor 400 can be divided into two blocks of eight elements to effectuate a scheme where M is eight. A tensor can include any number of elements and blocks. For N:M sparsity, there is at most N non-zero values in every set of M contiguous value positions. For example, tensor 400 exhibits 1:4 semi-structured sparsity if in any aligned contiguous block of four elements, there exists at most one non-zero value. The location of the non-zero value may vary from block to block. A sparsity mask for tensor 400 can be computed by identifying or otherwise selecting a most significant set of elements 402 from each block 410 and masking the unselected elements. The most significant elements can be selected as the elements having the highest values which can be computed as absolute values. For example, to compute a mask for 1:4 sparsity, the computing system can select the element having the highest value within each block and mask the remaining elements. The remaining elements can be masked by replacing their values with zeros.

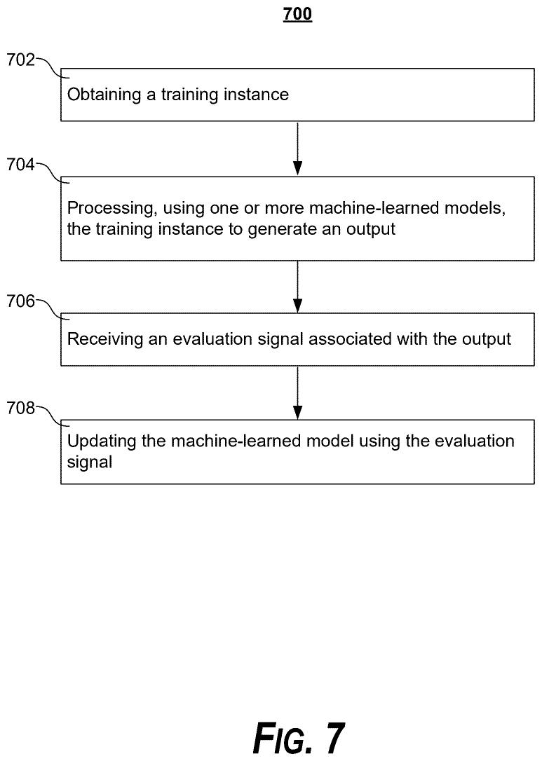

FIG. 5 is a block diagram depicting an example of a tensor 500 and particular values to further illustrate a technique of masking to induce sparsity. Tensor 500 is depicted at 520 before masking at 522 after masking. Tensor 500 includes four blocks 510-1, 510-2, 510-3, and 510-4, each containing four elements 502. Only the first element is labeled for clarity. In this example, the computing system computes a 2:4 sparsity mask for each block 510 of the tensor. Consider block 510-1, for example, which has values 10, 1, 7, and 4. The computing system identifies or otherwise selects the first element 502 and the third element as having the highest values and the second and fourth elements as having the lowest values. The computing system generates a sparsity mask that masks the second and fourth elements. The computing system can apply the sparsity mask to tensor 500 to cause the values of the second and fourth elements to be replaced with zero values. Similarly, the computing system generates a sparsity mask for block 510-2 by identifying the first and second elements as the most significant elements and masking the third and fourth elements. The computing system generates a sparsity mask for block 510-3 by identifying the second and third elements as the most significant elements and masking the first and fourth elements. The computing system generates a sparsity mask for block 510-4 by identifying the third and fourth elements as the most significant elements and masking the first and second elements.

### Example Methods

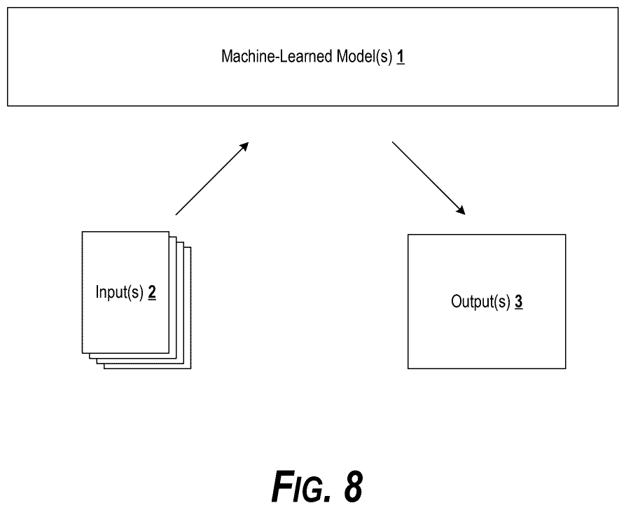

FIG. 6 is a flowchart depicting a method 600 for training a machine-learned model to induce sparsity during a fine-tuning process. One or more portion(s) of example method 600 and the other methods described here can be implemented by a computing system that includes one or more computing devices such as, for example, a machine-learned computing system including a training system as described herein. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, method 600 can include fine-tuning a pretrained machine-learned model during a first set of training steps. For example, a training computing system can perform fine-tuning on a pretrained model using one or more training datasets. As described herein, the model can include one or more weights or activations represented by a tensor. During the first set of training steps, the computing system can perform standard or dense fine-tuning without masking for a fraction of the overall fine-tuning steps. In an example implementation, the training computing system can perform standard or dense fine-tuning for 1/10th of (e.g., 10,000) of the overall fine-tuning steps (e.g., 100,000 training steps). Although not shown, method 600 can include pretraining the machine-learned model prior to fine-tuning. For example, the model can be pretrained using one or more training datasets. Typically, pretraining can include a larger amount of data and training steps (e.g., one million) than fine-tuning.

At 604, method 600 can include generating a sparsity mask for at least one tensor of the machine-learned model after the first set of training steps. In some examples, a sparsity mask can be generated for each tensor of the model. A sparsity mask can be generated by selecting the most significant or top N value elements from each block of M elements in the tensor and generating the sparsity mask for the unselected value elements.

At 606, method 600 can include applying the sparsity mask to the at least one tensor. The sparsity mask can include zero values for the unselected elements within each block of the tensor.

At 608, method 600 can include fine-tuning the machine-learned model during a second set of training steps with the sparsity mask applied to the at least one tensor. For example, the computing system can continue fine-tuning the model for the remaining fine-tuning steps after applying the sparsity mask. In some examples, the sparsity mask can be applied during all of the remaining steps of fine-tuning. In other examples, the computing system can recompute and re-apply the sparsity mask after a predetermined number of training steps.

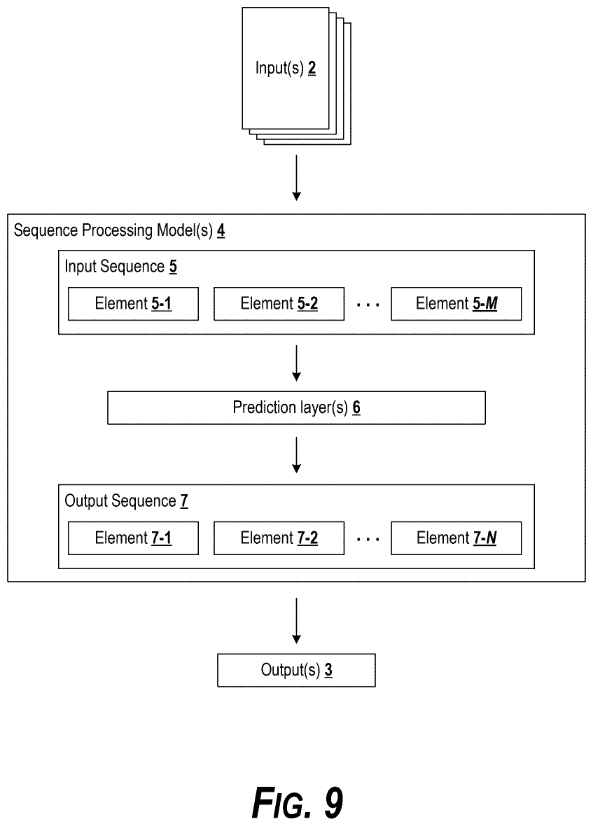

FIG. 7 depicts a flowchart of a method 700 for training one or more machine-learned models according to aspects of the present disclosure. For instance, an example machine-learned model can include a cross-modal adapter, text embedding model, image embedding model, text projection model, or image projection model. The example method can be used to train a machine-learned system including multiple machine-learned models or layers. The example method can be used for end-to-end training in which training data is processed through multiple models to determine an output.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

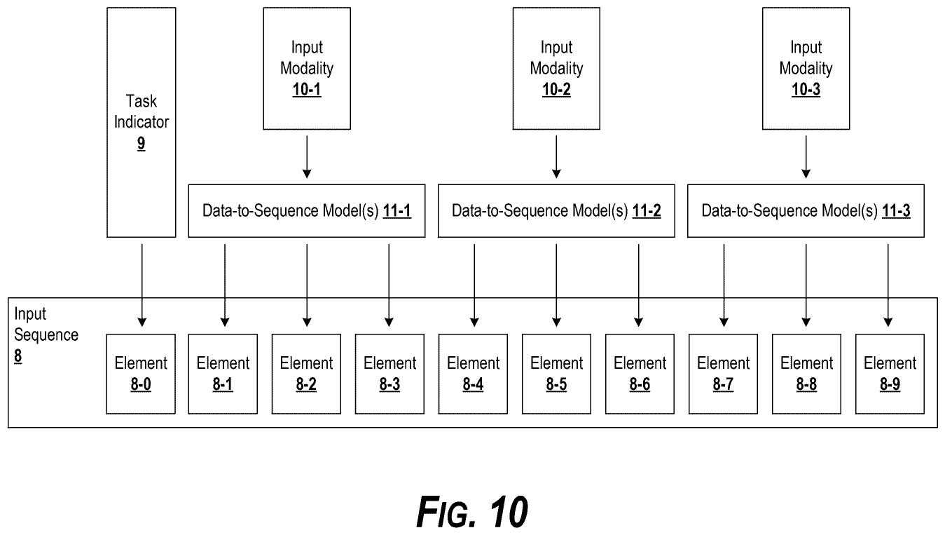

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

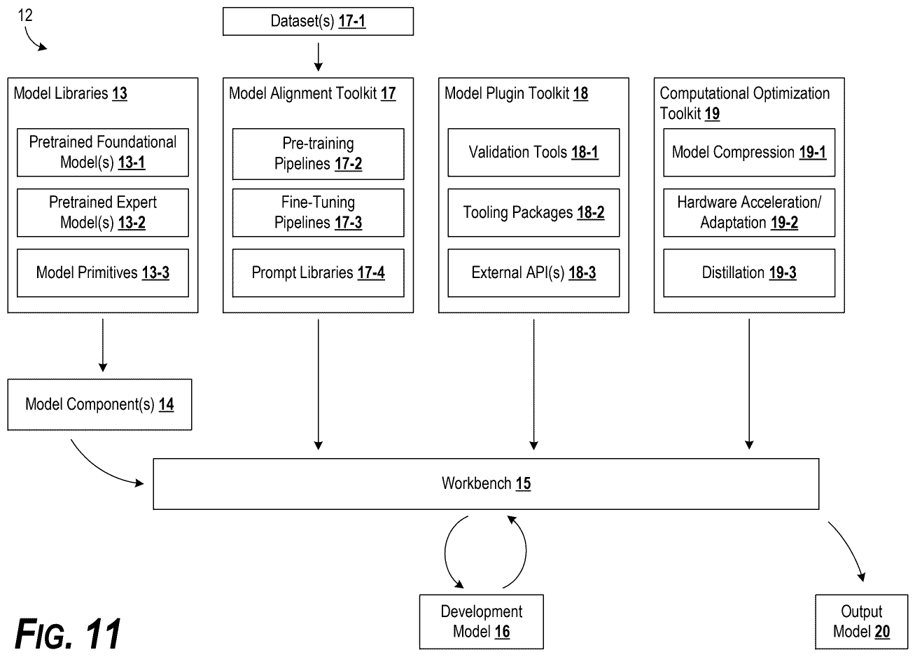

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

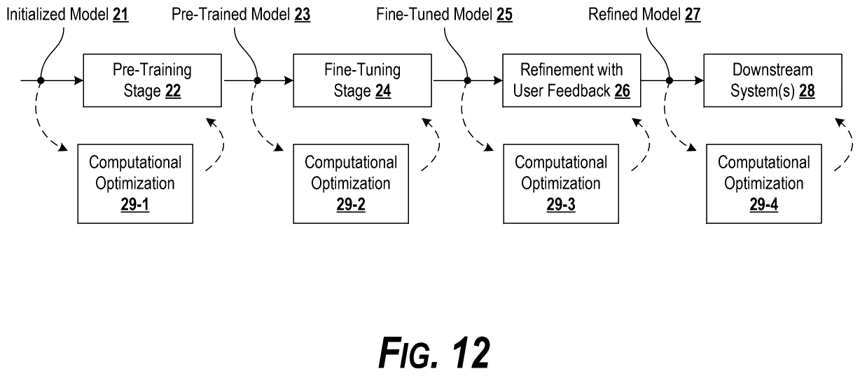

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

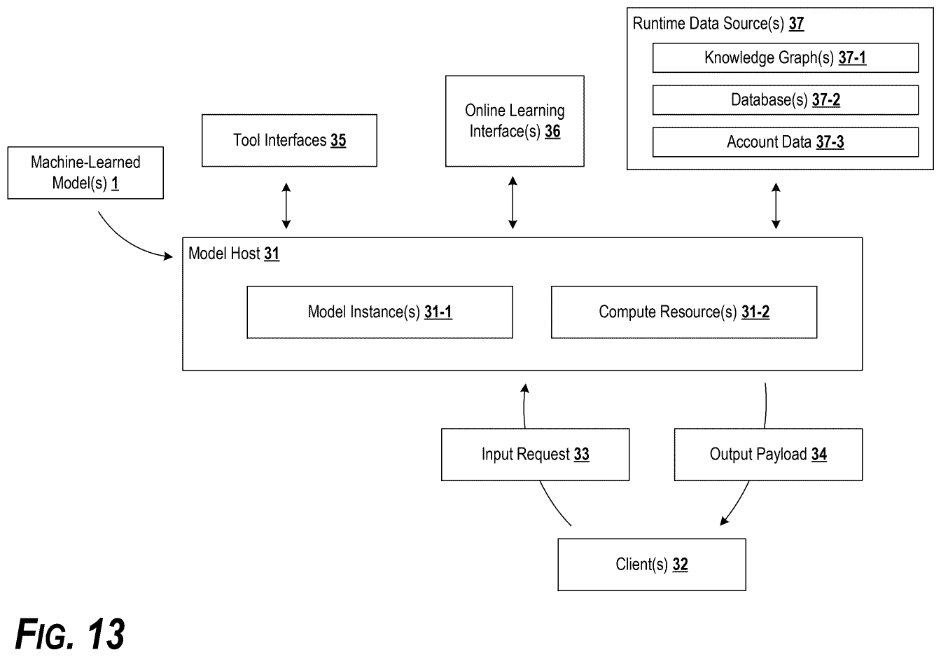

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 29 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

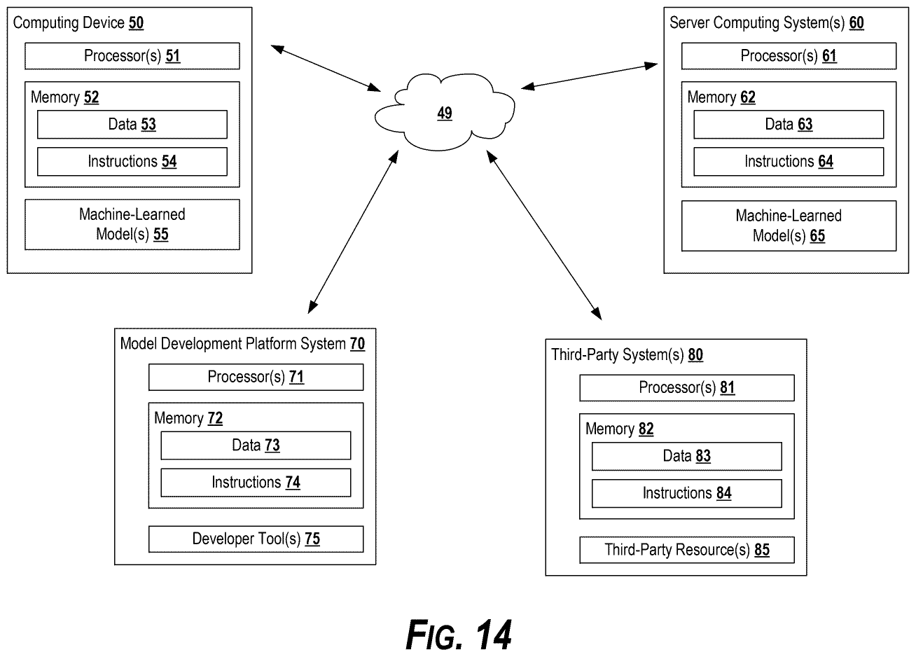

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

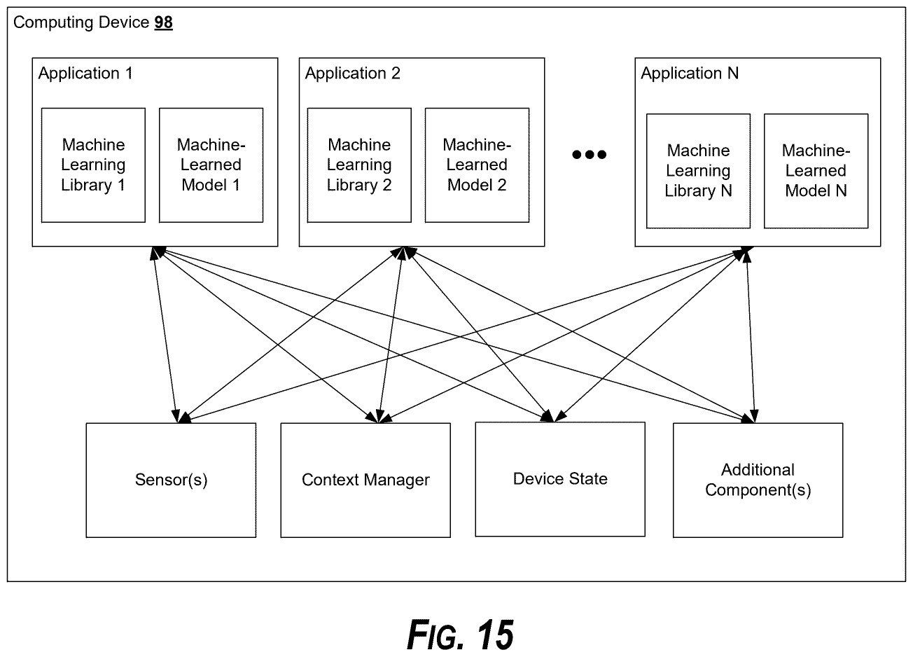

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

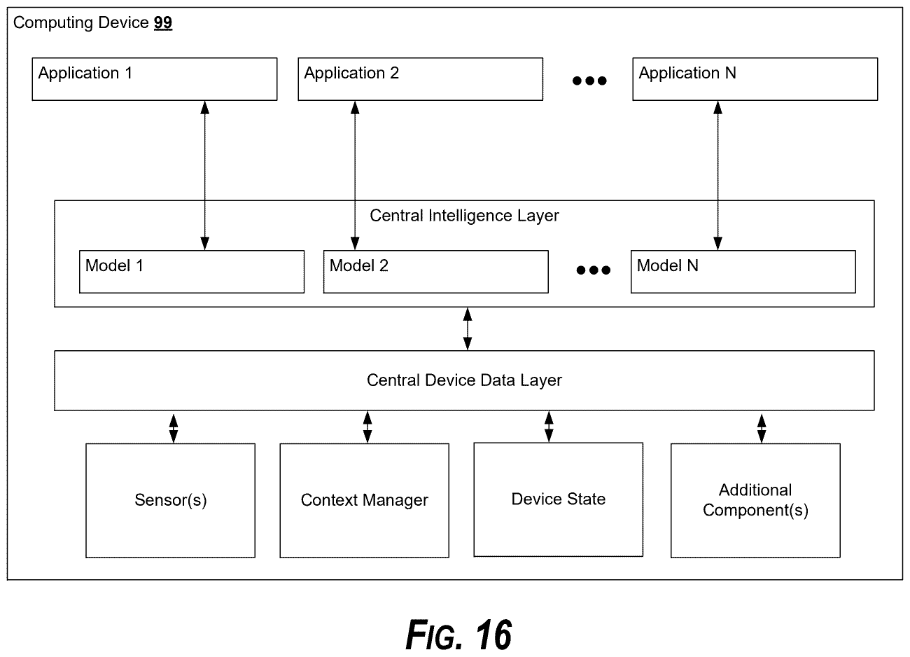

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, performed by a computing system comprising one or more computing devices, comprising:
fine-tuning a machine-learned model during a first set of training steps, the machine-learned model having been pre-trained on at least one set of training data;
generating a sparsity mask for at least one of a plurality of tensors of the machine-learned model after the first set of training steps;
applying the sparsity mask to the at least one of the plurality of tensors of the machine-learned model, the sparsity mask including a zero value for at least one element within each block of the at least one of the plurality of tensors; and
fine-tuning the machine-learned model during a second set of training steps with the sparsity mask applied to the at least one of the plurality of tensors.

2. The computer-implemented method of claim 1, wherein:
the at least one tensor includes a plurality of blocks, each block having a plurality of elements;
generating the sparsity mask for the at least one of the plurality of tensors of the machine-learned model after the first set of training steps, comprises:
selecting at least one element from each block of the at least one tensor, the at least one element from each block having a top value among the plurality of elements of said each block; and
masking at least one unselected element from each block of the at least one tensor.

3. The computer-implemented method of claim 2, wherein selecting the at least one element from each block comprises:
applying N:M sparsity to the plurality of elements of each block.

4. The computer-implemented method of claim 1, wherein:
the sparsity mask is a first sparsity mask;
the method further comprises:
generating a second sparsity mask for the plurality of tensors of the machine-learned model after fine-tuning the machine-learned model during the second set of training steps with the first sparsity mask applied to the plurality of tensors;
applying the second sparsity mask to the at least one of the plurality of tensors of the machine-learned model, the second sparsity mask including a zero value for at least one element within each block of the at least one of the plurality of tensors; and
fine-tuning the machine-learned model during a third set of training steps with the second sparsity mask applied to the at least one of the plurality of tensors.

5. The computer-implemented method of claim 4, further comprising:
fine-tuning the machine-learned model during a fourth set of training steps without masking the at least one of the plurality of tensors.

6. The computer-implemented method of claim 1, wherein:
the machine-learned model includes a plurality of layers including an initial layer, a final layer, and one or more intermediate layers between the initial layer and the final layer;
the plurality of tensors is part of the one or more intermediate layers; and
fine-tuning the machine-learned model during the second set of training steps is performed without masking tensors of the initial layer and the final layer of the machine-learned model.

7. The computer-implemented method of claim 1, further comprising:
deploying the machine-learned model;
providing at least one input to the machine-learned model; and
processing the at least one input with the plurality of tensors of the machine-learned model, wherein processing the at least one input includes skipping at least one calculation based on an indication of sparsity associated with the at least one tensor of the plurality of tensors.

8. The computer-implemented method of claim 1, further comprising:
pre-training the machine-learned model using the at least one set of training data.

9. The computer-implemented method of claim 1, wherein:
each of the plurality of tensors includes a weight or an activation of the machine-learned model.

10. The computer-implemented method of claim 1, wherein:
the machine-learned model is a large language model.

11. A system, comprising:
one or more processors; and
one or more non-transitory computer-readable media that collectively store computer instructions, that when executed by the one or more processors, cause the one or more processors to perform operations, the operations comprising:
fine-tuning a machine-learned model during a first set of training steps, the machine-learned model having been pre-trained on at least one set of training data;
generating a sparsity mask for at least one of a plurality of tensors of the machine-learned model after the first set of training steps;
applying the sparsity mask to the at least one of the plurality of tensors of the machine-learned model, the sparsity mask including a zero value for at least one element within each block of the at least one of the plurality of tensors; and
fine-tuning the machine-learned model during a second set of training steps with the sparsity mask applied to the at least one of the plurality of tensors.

12. The system of claim 11, wherein:
the at least one tensor includes a plurality of blocks, each block having a plurality of elements;
generating the sparsity mask for the at least one of the plurality of tensors of the machine-learned model after the first set of training steps, comprises:
selecting at least one element from each block of the at least one tensor, the at least one element from each block having a top value among the plurality of elements of said each block; and
masking at least one unselected element from each block of the at least one tensor.

13. The system of claim 12, wherein selecting the at least one element from each block comprises:
applying N:M sparsity to the plurality of elements of each block.

14. The system of claim 11, wherein:
the sparsity mask is a first sparsity mask;
the operations further comprise:
generating a second sparsity mask for the plurality of tensors of the machine-learned model after fine-tuning the machine-learned model during the second set of training steps with the first sparsity mask applied to the plurality of tensors;
applying the second sparsity mask to the at least one of the plurality of tensors of the machine-learned model, the second sparsity mask including a zero value for at least one element within each block of the at least one of the plurality of tensors; and
fine-tuning the machine-learned model during a third set of training steps with the second sparsity mask applied to the at least one tensor.

15. The system of claim 14, further comprising:
fine-tuning the machine-learned model during a fourth set of training steps without masking the at least one of the plurality of tensors.

16. One or more non-transitory computer-readable media storing computer instructions, that when executed by one or more processors, cause the one or more processors to perform operations, the operations comprising:
fine-tuning a machine-learned model during a first set of training steps, the machine-learned model having been pre-trained on at least one set of training data;
generating a sparsity mask for at least one of a plurality of tensors of the machine-learned model after the first set of training steps;
applying the sparsity mask to the at least one of the plurality of tensors of the machine-learned model, the sparsity mask including a zero value for at least one element within each block of the at least one of the plurality of tensors; and
fine-tuning the machine-learned model during a second set of training steps with the sparsity mask applied to the at least one of the plurality of tensors.

17. The one or more non-transitory computer-readable media of claim 16, wherein:
the at least one tensor includes a plurality of blocks, each block having a plurality of elements;
generating the sparsity mask for the at least one of the plurality of tensors of the machine-learned model after the first set of training steps, comprises:
selecting at least one element from each block of the at least one tensor, the at least one element from each block having a top value among the plurality of elements of said each block; and
masking at least one unselected element from each block of the at least one tensor.

18. The one or more non-transitory computer-readable media of claim 17, wherein selecting the at least one element from each block comprises:
applying N:M sparsity to the plurality of elements of each block.

19. The one or more non-transitory computer-readable media of claim 16, wherein:
the sparsity mask is a first sparsity mask;
the operations further comprise:
generating a second sparsity mask for the plurality of tensors of the machine-learned model after fine-tuning the machine-learned model during the second set of training steps with the first sparsity mask applied to the plurality of tensors;
applying the second sparsity mask to the at least one of the plurality of tensors of the machine-learned model, the second sparsity mask including a zero value for at least one element within each block of the at least one of the plurality of tensors; and
fine-tuning the machine-learned model during a third set of training steps with the second sparsity mask applied to the at least one tensor.

20. The one or more non-transitory computer-readable media of claim 19, wherein the operations further comprise:
fine-tuning the machine-learned model during a fourth set of training steps without masking the at least one of the plurality of tensors.
